(19) United States
(12) Patent Application Publication
(10) Pub. No.: US 2020/0273308 A1
(43) Pub. Date: Aug. 27, 2020

(54) TEMPERATURE RISING EARLY WARNING SYSTEM AND THE METHOD THERE OF

(71) Applicant: TAIWAN BUSWAY CO., LTD., TAOYUAN CITY (TW)

(72) Inventor: CHIA-YUN HUNG, TAOYUAN CITY (TW)

(73) Assignee: TAIWAN BUSWAY CO., LTD., TAOYUAN CITY (TW)

(21) Appl. No.: 16/798,372

(22) Filed: Feb. 23, 2020

(30) Foreign Application Priority Data
Feb. 23, 2019 (TW) 108106136

(51) Int. Cl. G08B 17/06; G08B 17/117; G08B 17/12

(52) U.S. Cl. CPC G08B 17/06; G08B 17/12; G08B 17/117

(57) ABSTRACT

The temperature rising early warning system comprises at least one thermosensitive release material, a sensor, a first warning unit, an analog digital converter, a microprocessor, a memory unit, a second warning unit, a transmission unit and a display unit. The thermosensitive release material comprises a thermosensitive material configured to release specific gases or particles at a critical temperature. The sensor is configured to detect the specific gases or the particle released by the thermosensitive release material and send out a signal.

### BACKGROUND OF THE INVENTION

### Field of the Disclosure

This invention discloses a temperature rising early warning system and its related method, in particular to a temperature rising early warning system and a temperature rising early warning method with thermosensitive release materials.

### Description of Related Art

There are many types of fire early-warning detection technologies, and the most widely used is smoke detection method. However, regarding the smoke detection method, the flame cannot be detected until the smoke being generated by the flame itself. It is not possible to inform personnel before the flame being generated. In addition, many factories store flammable materials. Thus, once the flame was generated, it is difficult to be controlled. Even if it was controlled, serious losses might not be avoided.

Therefore, it is worthy for those who having ordinary skill in the art, to think about how to notify relevant personnel in advance and deal with the fire immediately.

### SUMMARY OF THE INVENTION

The purpose of the present disclosure is to provide a temperature rising early warning system and method that could generate an early warning to relevant personnel about an imminent fire.

The temperature rising early warning system in the present disclosure comprises at least one thermosensitive release material and a sensor. The thermosensitive release material comprises a thermal sensitive material configured to release specific gases or particles at a critical temperature. The sensor is configured to detect the specific gases or the particles released by the thermosensitive release material and send out a signal. Optionally, the temperature rising early warning system further comprises a first warning unit, an analog digital converter, a microprocessor, a memory unit, a second warning unit, a transmission unit and a display unit.

In the above temperature rising early warning system, the critical temperature of the thermosensitive release material is less than 300° C.

In the above temperature rising early warning system, the critical temperature of the thermosensitive release material is less than 160° C.

In the above temperature rising early warning system, when a temperature of the thermosensitive release material is greater than the critical temperature, the color of the thermosensitive release material will be changed.

In the above temperature rising early warning system, the thermosensitive release material is a polymer, the composition of the specific gases or the particles contains at least one of sulfur atoms and nitrogen atoms.

In the above temperature rising early warning system, a strength of the signal transmitted by the sensor is corresponding to a concentration of the specific gases or number of the particles.

In the above temperature rising early warning system, a first warning unit is electrically connected to the sensor. The first warning unit receives the signal transmitted from the sensor. When the strength of the signal is greater than a first presetting value, a first warning signal will be sent out by the first warning unit.

In the above temperature rising early warning system, at least one analog digital converter and at least one microprocessor are further provided. The analog digital converter is electrically connected to the sensor. The analog digital converter is configured to convert the signal to a digital signal. The microprocessor is electrically connected to the analog digital converter. The microprocessor is configured to receive the digital signal from the analog digital converter to generate a statistical data.

In the above temperature rising early warning system, the statistical data is the signal strength detected by the sensor versus time.

In the above temperature rising early warning system, the memory unit is electrically connected to the microprocessor and configured to store the statistical data generated by the microprocessor.

In the above temperature rising early warning system, the second warning unit is electrically connected to the microprocessor. When the strength of the signal of the statistical data generated by the microprocessor reaches a second presetting value, a second warning signal will be sent out by the second warning unit.

In the above temperature rising early warning system, the display unit is electrically connected to the microprocessor via the transmission unit. The display unit is configured to receive and display the statistical data generated by the microprocessor or the second warning signal generated by the second warning unit.

In the above temperature rising early warning system, the display unit is a mobile device.

A temperature rising early warning method comprises: A thermosensitive release material is placed in the vicinity of a potential heat source; When the thermosensitive release material reaches a critical temperature, the specific gases or particles are released by the thermosensitive release material; Place a sensor in the vicinity of the thermosensitive release material to detect the specific gases or particles released by the thermosensitive release material and send out a signal.

In the above temperature rising early warning method, the thermosensitive release material is a polymer, the specific gases or the particles contain at least one of sulfur atoms and nitrogen atoms.

In some embodiment, the above temperature rising early warning method further comprises a first warning unit. The first warning unit receives the signal transmitted from the sensor. When a strength of the signal is greater than a first presetting value, a first warning signal will be sent out by the first warning unit.

In some embodiment, the above temperature rising early warning method further comprises transmitting the signal detected by the sensor to a microprocessor to generate a calculated statistical data.

In some embodiment, the above temperature rising early warning method further comprises storing the statistical data generated by the microprocessor to a memory unit.

In some embodiment, the above temperature rising early warning method further comprises a second warning unit. A second warning signal is sent out by the second warning unit when a strength of the signal of the statistical data generated by the microprocessor reaches a second presetting value.

In some embodiment, the above temperature rising early warning method further comprises providing at least one transmission unit and at least one display unit, wherein the display unit is electrically connected to the microprocessor via the transmission unit and configured to receive and display the statistical data generated by the microprocessor, or the second warning signal generated by the second warning unit.

In order to make the above features and advantages clearer and easier to be understood, the preferred embodiments with the accompanying drawings are listed as the following detail description.

### BRIEF DESCRIPTION OF THE DRAWINGS

FIG. 1 illustrates a temperature rising early warning system of present embodiment;

FIG. 2 illustrates an experiment chart of thermosensitive release material;

FIG. 3 illustrates another embodiment in accordance with the temperature rising early warning system

FIG. 4 illustrates a flow chart of a temperature rising early warning method.

### DESCRIPTION OF THE INVENTION

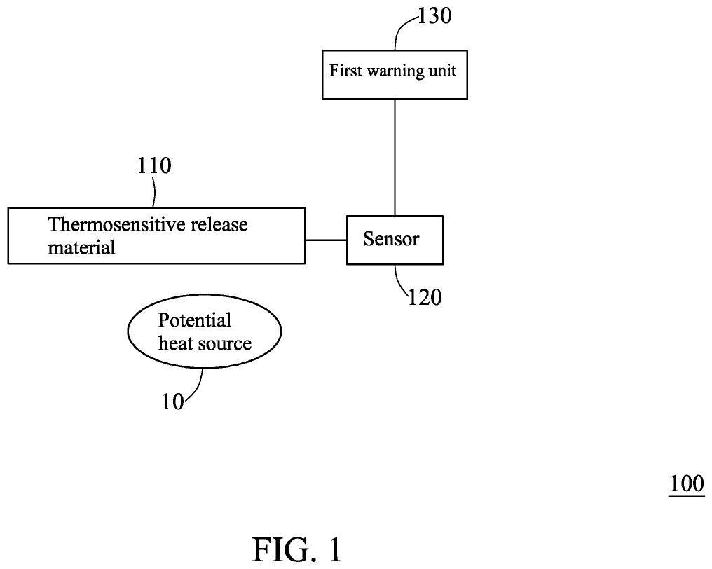

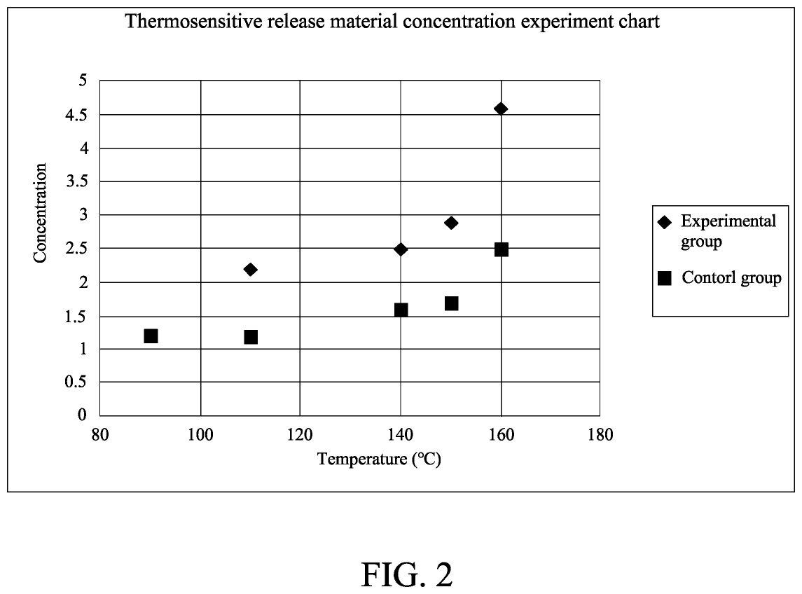

Please refer to FIG. 1 and FIG. 2. FIG. 1 illustrates a temperature rising early warning system 100 in accordance with an embodiment of the present disclosure. FIG. 2 illustrates an experiment chart of thermosensitive release material. The temperature rising early warning system 100 includes a thermosensitive release material 110, a sensor 120 and a first warning unit 130. The thermosensitive release material 110 is placed in the vicinity of a potential heat source 10 by a user. For example, the potential heat source 10 is an appliance that generate heat during use, a chemical or a location in warehouses that may generate heat and cause a fire. The thermosensitive release material 110 is, for example, a polymer. The polymer is made by mixing one or more organic polyamine compounds with silicone rubber. When the temperature of the potential heat source 10 is raised, and heats up the nearby thermosensitive release material 110 to a critical temperature, the thermosensitive release material 110 will be thermally decomposed to release small molecules of nitrogen-containing specific gases or particles to the external environment. The specific gases or particles are selected from the group contained at least one of sulfur atoms and nitrogen atoms. In an experiment, the thermosensitive release material of the present disclosure can be an experimental group, and ordinary silicone rubber does not contain one or more organic polyamines is used as a control group. The material of the experimental group or the material of the control group is placed on a heat source (The heat source for the experiment is a hot plate). A gas sensor is placed in the vicinity of the heat source to measure the relative concentration of nitrogen in the air. The measurement results are shown in FIG. 2. When the temperature is 90° C., the difference between the relative concentrations of the nitrogen element measured by the gas sensors in the experimental group and the control group is very small, so the measure results appear to overlap in FIG. 2. However, when the temperature is higher than 110° C., the nitrogen concentration measured by the gas sensor in the experimental group is greater than that of the control group. Therefore, the thermosensitive release material has an early warning effect in a warming environment. According to the data in FIG. 2, if an induction temperature of a potential heat source is set to 110° C., the warning concentration threshold of the gas sensor can be adjusted to 2. Thus, when the temperature of the potential heat source is greater than 110° C., the sensor will send out a warning message. If the induction temperature is set to 160° C., then the warning concentration threshold of the gas sensor can be adjusted to 4, and so on. To be reminding is that, the concentration scale in FIG. 2 is a relative value of the sensor. The unit of the relative value can be a signal indicator value, a weight percentage (wt %) or parts per million(ppm). In the embodiment, the critical temperature at which the thermosensitive release material 110 releases the specific gases or the particles is less than 300° C. In a preferred embodiment, the critical temperature at which the thermosensitive release material 110 releases the specific gases or the particles is less than 160° C. Furthermore, the sensor 120 is configured to detect the specific gases or the particles released by the thermosensitive release material 110, and the sensor 120 is placed in the vicinity of the thermosensitive release material 110. The sensor 120 is configured to detect a signal of the specific gases or the particles released by the thermosensitive release material 110. For example, the signal is a concentration of the specific gases, or number of the particles, and the signal generated by the sensor 120 is transmitted to the first warning unit 130. In addition, the first warning unit 130 is configured to receive the signal generated by the sensor 120 at any time. A first warning signal generated by the first warning unit 130 is sent out notify on-site personnel when the strength of the signal is greater than a first presetting value. Furthermore, a color of the thermosensitive release material will be changed when a temperature of the thermosensitive release material achieves (greater than or equal to) the critical temperature. In another embodiment, a plurality of the thermosensitive release materials 110 is arranged near a plurality of potential heat sources but only one sensor 120 is used. As a result, when the on-side personnel receive the first warning signal from the first warning unit 130, a position of the potential heat source with an excessively high temperature can be recognized by the color change of the thermosensitive release material 110, so that the on-site personnel can take immediate action to avoid the fires in time.

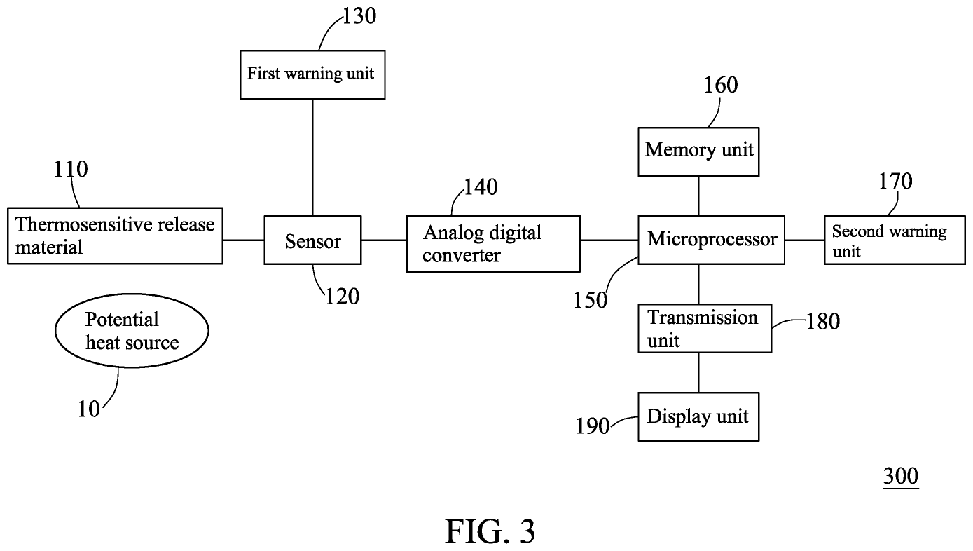

Please refer to FIG. 3. FIG. 3 illustrates a temperature rising early warning system 300 in accordance with another embodiment. The temperature rising early warning system 300 is configured for remote monitoring. The differences between the temperature rising early warning system 300 and the temperature rising early warning system 100 are the temperature rising early warning system 300 includes an analog digital converter 140, a microprocessor 150, a memory unit 160, a second warning unit 170, a transmission unit 180 and a display unit 190. The analog digital converter 140 is configured to receive the analog signal from the sensor 120 and convert the analog signal to a digital signal. The digital signal is transmitted to the microprocessor 150 to generate a statistical data of a strength of the signal with the specific gases or the particles released by the thermosensitive release material 110 in relative time. The statistical data could be stored in the memory unit 160. The statistical data is transmitted, by the transmission unit 180 in a wireless or wired manner, to the display unit 190 and displayed. Furthermore, the second warning unit 170 is configured to receive the signal of the statistical data generated by the microprocessor 150 at any time. When the strength of the signal is greater than a second presetting value, the second warning unit 170 transmits a second warning signal via the transmission unit 180 to the display unit 190 to display. Moreover, the display unit 190 can be a display screen of a desktop computer, a display screen of a laptop, or a display screen of a mobile device. As a result, the temperature rising early warning system 300 enables both on-site and off-site personnel to know the situation of the heat source has occurred. In some embodiments, the first warning unit 130 in the temperature rising early warning system 300 may be omitted, and the off-site personnel directly operates via remote monitoring. In some embodiments, the second warning unit 170 in the temperature rising early warning system 300 may be omitted, and only the on-site personnel can obtain the warning signal in time. That is, the first warning unit 130 or the second warning unit 170 can be built at least one in the temperature rising early warning system for the warning purpose.

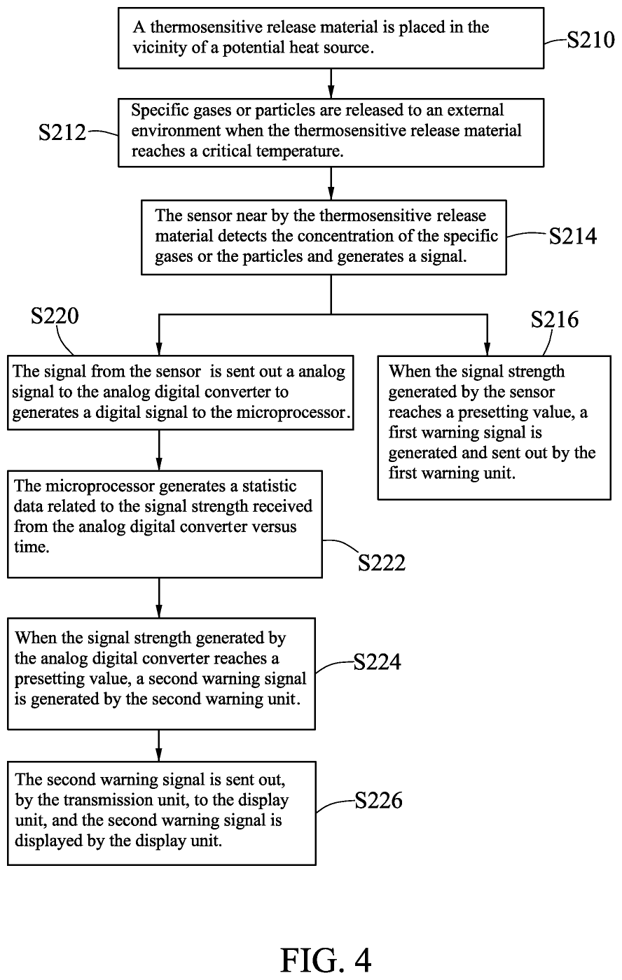

Please refer to FIG. 1, FIG. 3 and FIG. 4, FIG. 4 illustrates a flow chart of a temperature rising early warning method. First, in the step S210, a thermosensitive release material 110 is placed in the vicinity of a potential heat source 10. Then, in the step S212, specific gases or particles are released to an external environment when the thermosensitive release material 110 reaches a critical temperature. The specific gases or the particles contain at least one of sulfur atoms and nitrogen atoms. Then, in the step S214, the sensor 120 near by the thermosensitive release material 110 detects the concentration of the specific gases or the particles and generates a signal. Then, in the step S216, When the signal strength generated by the sensor reaches a presetting value, a first warning signal is generated and sent out by the first warning unit 130. Another embodiment, for example, the step S220 is implemented after the step S214, and in the step S220 the signal from the sensor 120 is sent out a analog signal to the analog digital converter 140 to generates a digital signal to the microprocessor 150. Then, in the step S222, The microprocessor 150 generates a statistic data related to the signal strength received from the analog digital converter 140 versus time. Then, in the step S224, When the signal strength generated by the analog digital converter 140 reaches a presetting value, a second warning signal is generated by the second warning unit 170. Then, in the step S226, the second warning signal is sent out, by the transmission unit 180, to the display unit 190, and the second warning signal is displayed by the display unit 190.

In summary, the temperature rising early warning system and the temperature rising early warning method in the present disclosure can remind the on-site and off-site personnel in advance that the temperature of the environment is too high, a fire is about to occur, and an immediate action is required to prevent the fire. Furthermore, the personnel can check the past records to see if something abnormal happened.

Although the description above contains many specifics, these are merely provided to illustrate the invention and should not be construed as limitations of the invention's scope. Thus, it will be apparent to those skilled, in the art that various modifications and variations can be made in the system and processes of the present disclosure without departing from the spirit or scope of the invention.

What is claimed is:

1. A temperature rising early warning system comprising:
at least one thermosensitive release material configured to release specific gases or particles in a critical temperature; and
at least one sensor configured to detect the specific gases or the particles released by the thermosensitive release material and send out a signal.

2. The temperature rising early warning system of claim 1 wherein the critical temperature of the thermosensitive release material is less than 300° C.

3. The temperature rising early warning system of claim 1 wherein the critical temperature of the thermosensitive release material is less than 160° C.

4. The temperature rising early warning system of claim 1 wherein a color of the thermosensitive release material will be changed when a temperature of the thermosensitive release material is greater than the critical temperature.

5. The temperature rising early warning system of claim 1 wherein the thermosensitive release material is a polymer, the specific gases or the particles contain at least one of sulfur atoms and nitrogen atoms.

6. The temperature rising early warning system of claim 1 wherein a strength of the signal transmitted from the sensor is corresponding to a concentration of the specific gases or number of the particles.

7. The temperature rising early warning system of claim 1 further comprising:
a first warning unit electrically connected to the sensor;
wherein the first warning unit receives the signal transmitted from the sensor, and a first warning signal is sent out by the first warning unit when a strength of the signal is greater than a first presetting value.

8. The temperature rising early warning system of claim 1 further comprising:
at least one analog digital converter electrically connected to the sensor, the analog digital converter configured to convert the signal to a digital signal; and
at least one microprocessor electrically connected to the analog digital converter, the microprocessor configured to receive the digital signal from the analog digital converter to generate a statistical data.

9. The temperature rising early warning system of claim 8 wherein the statistical data is the signal strength detected by the sensor versus time.

10. The temperature rising early warning system of claim 8 further comprising:
at least one memory unit electrically connected to the microprocessor and configured to store the statistical data generated by the microprocessor.

11. The temperature rising early warning system of claim 8 further comprising:
at least one transmission unit; and
at least one display unit electrically connected to the microprocessor via the transmission unit, the display unit configured to receive and display the statistical data generated by the microprocessor.

12. The temperature rising early warning system of claim 11 further comprising:
a second warning unit electrically connected to the microprocessor;
wherein a second warning signal is sent out by the second warning unit when a strength of the signal of the statistical data generated by the microprocessor reaches a second presetting value.

13. The temperature rising early warning system of claim 12 wherein the display unit is a mobile device.

14. A temperature rising early warning method comprising:
placing a thermosensitive release material in the vicinity of a potential heat source;
releasing specific gases or particles by the thermosensitive release material when the thermosensitive release material reaches a critical temperature; and
placing a sensor in the vicinity of the thermosensitive release material, the sensor configured to detect the specific gases or the particles released by the thermosensitive release material and send out a signal.

15. The temperature rising early warning method of claim 14 wherein the thermosensitive release material is a polymer, the specific gases or the particles contain at least one of sulfur atoms and nitrogen atoms.

16. The temperature rising early warning method of claim 14 further comprising:
providing a first warning unit; wherein the first warning unit receives the signal transmitted from the sensor, and when a strength of the signal is greater than a first presetting value, a first warning signal is sent out by the first warning unit.

17. The temperature rising early warning method of claim 14 further comprising:
transmitting the signal detected by the sensor to a microprocessor to generate a calculated statistical data.

18. The temperature rising early warning method of claim 17 further comprising:
storing the statistical data generated by the microprocessor to a memory unit.

19. The temperature rising early warning method of claim 17 further comprising:
providing at least one transmission unit and at least one display unit; wherein the display unit is electrically connected to the microprocessor by the transmission unit, the display unit is configured to receive and display the statistical data generated by the microprocessor.

20. The temperature rising early warning method of claim 19 further comprising:
providing a second warning unit;
wherein when a strength of the signal of the statistical data generated by the microprocessor reaches a second presetting value, a second warning signal is sent out by the second warning unit.
